(19) United States
(12) Patent Application Publication
(10) Pub. No.: US 2004/0150662 A1
(43) Pub. Date: Aug. 5, 2004

(54) Online system and method for assessing/certifying competencies and compliance

(76) Inventor: Douglas A. Beigel, West Friendship, MD (US)

Correspondence Address: Supervisor, Patent Prosecution Services, PIPER RUDNICK LLP, 1200 Nineteenth Street, N.W., Washington, DC, 20036-2412, US

(21) Appl. No.: 10/665,511

(22) Filed: Sep. 22, 2003

Related U.S. Application Data
(60) Provisional application No. 60/411,865, filed on Sep. 20, 2002.

(51) Int. Cl. G09G 5/00

(52) U.S. Cl. 345/707

(57) ABSTRACT

A system and method is provided for offering network-based evaluation, assessment and certification which can be utilized at great distances. The system allows for setting specific criteria for any given discipline, and allows participants to evaluate their own performance against any given applicable set of standards and independent third-party validation of performance by conducting an on-site survey using the same system. Individuals can evaluate their own competencies, compliance against the given criteria in the learning experience asynchronously, thereby taking advantage of diverse schedules. The standards can be set and administered either by a nation-state, professional society, or international or national standards setting organization. Thus, the present invention maybe utilized by educational organizations, accreditation organizations, nation-states, government agencies/ministries, professional societies, or international or national standards setting organizations.

This application claims priority from U.S. Provisional Application No. 60/411,865, filed Sep. 20, 2002. The entirety of that provisional application is incorporated herein by reference.

### BACKGROUND OF THE INVENTION

1. Field of the Invention

The present invention generally relates to computer applications, and more particularly to evaluation, assessment and certification applications.

2. Related Art

In today's technological climate, traditional assessment/certifying competencies and compliance organizations are limited by their physical resources and monetary constraints. That is, the number of participants to whom these organizations can market their intellectual property (i.e., services) are limited. As a result, these organizations (e.g., educational organizations, nation-states, government agencies/ministries, professional societies, international/national standards setting organizations and the like) have a relatively small consumer base (i.e., participants).

In addition, participant's fixed schedules, infrastructure costs, lack of scalability, and lack of custom approaches have limited traditional assessment/certifying competencies and compliance models. Currently, these models are paper-based systems that include one assessment/certifying competencies and compliance organization and many participants. One limitation of this prevailing model is manifested by it primarily being available only to people and organizations who can afford an extremely high cost of development and maintenance.

Known methods of offering distance assessment/certifying competencies and compliance approach have not been able to harness the assessment/certifying competencies and compliance techniques and material of some recognized, high-quality, world-leading institutions. Existing methods generally require that a participant become self taught with occasional periodic assessments by the assessment/certifying competencies and compliance organization.

Given the above-described problem, what is needed is a system, method and computer program product for an assessment/certifying competencies and compliance forum that provides interactive modules asynchronously such that a participant can participate in a module using an on-demand schedule while also reap the benefits of an interactive learning environment. A participant should not be bound by geographical constraints. Preferably the assessment/certifying competencies and compliance forum would provide accredited approaches leading to a certificate of accreditation, certification by a specific jurisdiction, a widely-respected organization's “seal of approval”, educational degree, professional society recognition and other assessment/certifying competencies and compliance recognition being granted.

### SUMMARY OF THE INVENTION

The present invention meets the above-identified needs by providing a collaborative assessment/certifying competencies and compliance system, method and computer program product for implementing innovative criteria fashioned into an electronic assessment/certifying competencies and compliance learning experience that can be utilized at great distances. Participants can participate in the assessment/certifying competencies and compliance learning experience asynchronously thereby taking advantage of diverse schedules.

In one embodiment, the present invention provides a system for offering online, Web-based assessment/certifying competencies and compliance evaluation and validation. In another embodiment, the present invention includes software running on a computer or a plurality of computers for delivering assessment/feedback services online. The software can perform an adaptive assessment following the progress of an individual participant. The system can be responsive to an assessment with remediation and guidance. In one embodiment, the system can be accessed via a Web interface.

In a preferred embodiment, modules are designed and developed to allow continuous updating and customization. Optionally, modules can be used in multiple assessment/certifying competencies and compliance applications.

In one embodiment, the invention includes a computer assessment system. The systems delivers, tracks progression of, assesses work product relating to and certify completion of assessment/feedback modules accessed by a participant. The system includes a computer application service provider network with a computer server and a network access device, each containing a processor, a storage medium (e.g., hard disk), and a display and being connected to a computer (wide area or local area) network. Executable software can be stored on the server storage medium and executed on demand via a Web access device.

The software operative with the processors can cause a module included in an assessment/certifying competencies and compliance learning engine to display on the network access device. The module can include a means for motivating the participant relating to subject matter contained in an assessment/feedback module, a means for selecting (e.g., a graphical user interface) an element of subject matter comprising the assessment/feedback matter, a means for facilitating understanding of the element of subject matter by the participant, a means for performing a task online by the participant, a means for evaluating the performance of the task performed online, a means responsive to the evaluation of performance, for explaining an aspect of the subject matter of the element, a means for assessing a participant's comprehension of subject matter presented in the module, and a means for certifying satisfactory comprehension of the subject matter presented in the learning engine.

In another embodiment, the present invention includes adaptive assessment and learning software. The adaptive assessment and learning software can track the participant who makes satisfactory or unsatisfactory responses and subsequently branch to an alternative learning module.

In still another embodiment, the present invention includes a method of interacting with a computer application service provider network so as to provide instruction to a participant. A participant can access a server with a network access device over a computer network and execute a software program comprising an assessment/certifying competencies and compliance learning engine wherein the assessment/certifying competencies and compliance learning engine can cause an education module to be presented to the participant. A participant may interact with the network access device such that the module will present assessment/certifying competencies and compliance material to the participant and facilitate understanding of the subject matter. The system also allows for external evaluation by on-site “surveyors” (e.g., employees of the ASP or standards-setting entity). This function can be used by educational organizations, accreditation organizations, nation-states, ministries of government, professional societies, or international or national standards setting organization (e.g., ISO, ANSI, etc.). In an embodiment, the software also includes a component that allows the surveyor to validate that the criteria are followed by producing a CD-ROM and an on-line data collection and transfer process.

An advantage of the present invention is that it allows assessment/certifying competencies and compliance modules to meet the specific needs of the entity employing it (e.g., educational organizations, accreditation organizations, nation-states, ministries of government, professional societies, international or national standards setting organizations or the like).

Further features and advantages of the present invention as well as the structure and operation of various embodiments of the present invention are described in detail below with reference to the accompanying drawings.

### BRIEF DESCRIPTION OF THE FIGURES

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram illustrating the general technical environment of the present invention.

FIG. 2 is a flowchart illustrating a user self-assessment process according to an embodiment of the present invention.

FIG. 3 is a flowchart illustrating a surveyor validation process model according to an embodiment of the present invention.

FIG. 4 is a block diagram of an exemplary computer system useful for implementing the present invention.

FIGS. 5A-I are exemplary windows or screen shots generated by the graphical user interface of the present invention.

### DETAILED DESCRIPTION

I. Overview

The present invention is directed to a system, method and computer program product for online assessing/certifying competencies and compliance.

In an embodiment, the present invention comprises a computer program product for assessment/certifying competencies and compliance learning engine (engine) offered online via a network of assessment/certifying competencies and compliance nodes. The engine can provide an assessment/certifying competencies and compliance experience wherein, interactive modules are utilized and content is designed in cooperation and partnership with assessment/certifying competencies and compliance organizations (e.g., educational organizations, nation-states, government agencies/ministries, professional societies, international/national standards setting organizations and the like). Course content can include building blocks of assessment/certifying competencies and compliance knowledge and be delivered using multiple vehicles.

In an embodiment of the present invention, an application service provider (ASP) organization (or the assessment/certifying competencies and compliance organization itself) provides and allows access, perhaps on a subscriber fee or pay-per-use basis, to a Web-based tool that allows evaluation, assessment and certification. That is, the service provider would provide the hardware (e.g., servers) and software (e.g., database) infrastructure (i.e., a platform), assessment application software, customer support, and billing mechanism to allow its customer-subscribers (e.g., individual employees, companies, members of a trade association and the like) to access the assessment application, use the application, upload assessment data, perform data analysis and generate and send reports via electronic mail.

In such an embodiment, certificates of accreditation, certifications, “seals of approval”, educational degrees, and any other professional recognition are granted entirely through online modules through the ASP (or the assessment/certifying competencies and compliance organization itself). Oversight functions such as registration, administrative tasks, and purchasing course materials are also accomplished online.

In a preferred embodiment of the present invention, a service provider organization provides and allows access, on a subscriber fee basis, to a platform that allows a laboratory medicine organization (e.g., an organization that tests human urine, blood, DNA samples or the like) to perform an assessment of its personnel and procedures based on a set of criteria (i.e., questions) specified by either the laboratory, a trade group or a state, local or federal governing body that has jurisdiction over the licensing of the laboratory. Such criteria, in the laboratory medicine organization example, would include: “Do you have a quality control manual?” or “Do you have a quality assurance plan?”

In an alternate embodiment, the set of criteria (and thus, the questions posed during execution of the assessment application provided by the ASP) would be created, developed and administered by the ASP itself acting as a certification body. Upon completion of the assessment, the present invention would provide a custom action plan to aid the laboratory medicine organization in compiling with any failed criteria. In an embodiment, such plan would include links to (affiliated or non-affiliated) e-learning Web sites so that such deficiencies may be corrected in time for subsequent evaluations.

The present invention is now described in more detail herein in terms of the above examples. This is for convenience only and is not intended to limit the application of the present invention. In fact, after reading the following description, it will be apparent to one skilled in the relevant art(s) how to implement the following invention in alternative embodiments.

The terms “personnel,” “user,” “entity,” “customer,” “organization,” “surveyor,” “administrator” and/or the plural form of these terms are used interchangeably throughout herein to refer to those who would access, use, be affected by and/or benefit from the tool that the present invention provides for online assessing/certifying competencies and compliance.

II. System Architecture

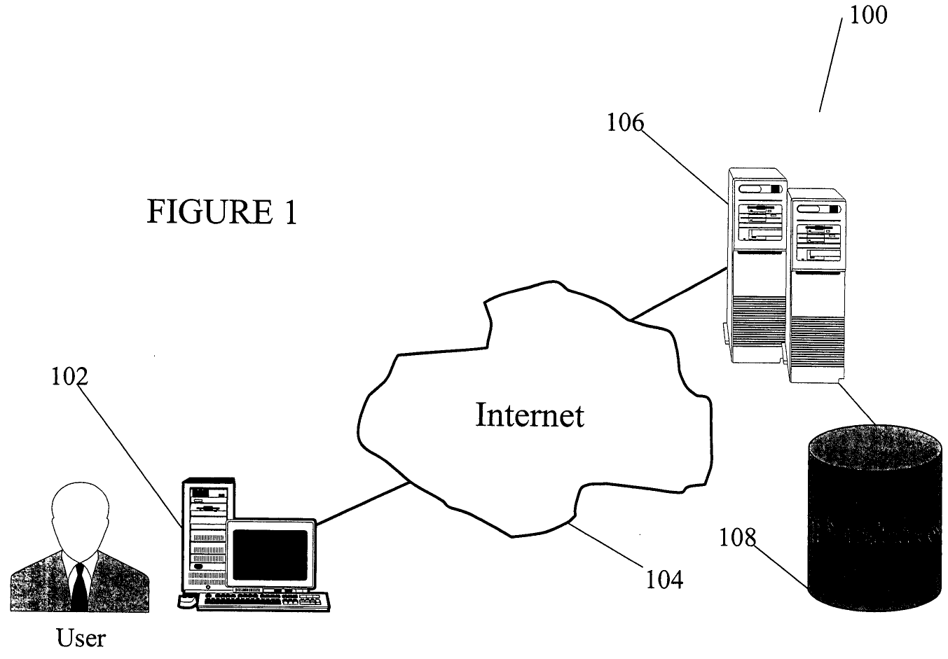

Referring to FIG. 1, a block diagram illustrating the technical environment in which the present invention would operate according to an embodiment of the present invention is shown.

A system 100 includes an end user (e.g., an individual, organization or surveyor user) who utilizes an access device 102 to access the global, public Internet 104 (and thus to browse the World Wide Web (WWW)). In alternate embodiments, accessing device 102 is a personal computer (PC) (e.g., an IBM® or compatible PC workstation running the Microsoft® Windows 95/98/2000/XP/NT® operating system, a Macintosh® computer running the Mac® OS operating system, or the like) equipped with browser software (e.g., Microsoft® Explorer, Netscape® Navigator or the like). In alternate embodiments, accessing device 102 is any processing device having a processor and a display including, but not limited to, a terminal, minicomputer, microcomputer, mainframe computer, laptop, palmtop, workstation, set-top box or personal digital assistant (PDA).

System 100 also includes Web server(s) 106 and a database 108. Web server 106 provides the “front end” for a Web site operated by the ASP or assessment/certifying competencies and compliance organization that allows access to its Web site over the Internet 104 via one or more Uniform Resource Locator addresses (URLs). That is, server 106 contains a Web server process running at a Web site which sends out Web pages in response to Hypertext Transfer Protocol (HTTP) or Hypertext Transmission Protocol, Secured (HTTPS) requests from remote browsers (i.e., one or more users utilizing device(s) 102). More specifically, it provides a graphical user interface (GUI) “front end” screens to users within system 100 in the form of Web pages. These Web pages, when sent to a user's terminal 102 (or the like), would result in GUI screens being displayed. In an embodiment, server 106 also contains software code logic that (is the “back-end” of system 100 and) controls the evaluation, assessment and certification processes described herein. In an embodiment of the present invention, server 106 is a Sun or NT workstation.

Server 106 has access to database 108, implemented, in one embodiment, with relational database management server software (e.g., Oracle 9 RDBMS or the like). Database 108 is the central store for information within system 100 for the entity operating the Web site(s) hosted by server 106 (e.g., login names, passwords, subscriber information, standards, criteria, evaluation and assessment questions, templates, scores, etc.). While one database 108 is shown in FIG. 1 for ease of explanation, it will be apparent to one skilled in the relevant art(s), that system 100 may utilize databases physically located on one or more computers which may be the same as any of the server(s) 106. Furthermore, in an embodiment of the present invention, database 108 can be mirrored for fault tolerance.

It will be apparent to one skilled in the relevant art(s), after reading the description herein, that system 100 is generally representative of a technical environment in which the present invention may operate. That is, system 100 is not intended to limit the environment where the present invention may operate. In fact, after reading the following description, it will be apparent to one skilled in the relevant art(s) that the present invention maybe implemented in alternative environments (e.g., on an intranet, extranet, dial-up, LAN, WAN, or stand-alone system executing on a CD-ROM, etc.).

More detailed descriptions of system 100 components, as well their functionality, are provided below.

III. Assessment Operational Overview

As will be appreciated by those skilled in the relevant art(s) after reading the description herein, registration with the ASP may be done by an employer or other sponsoring organization (e.g., a laboratory that is located in a particular jurisdiction and seeks accreditation or compliance certification from that jurisdiction or a standards-setting body operating within that jurisdiction). Once registered, the sponsoring organization's individual (authorized) personnel would then be able to access system 100 to take one or more self-assessments (i.e., courses) applicable to the sponsoring organization's business activities in order to gain individual accreditation or compliance certification. (For example, a standards body may require, in order for a laboratory to receive a particular certification, that certain of its personnel be certified as well.)

In an alternate embodiment, the user of system 100 would be one or more managerial personnel of the employer or other sponsoring organization (e.g., the administrator or director of the laboratory) who would access system 100 to take one or more self-assessments (i.e., courses) applicable to the entire operation of the sponsoring organization and thus no individual personnel of the sponsoring organization would need to access system 100. (For example, a standards body may require that a laboratory receive a particular certification, and allow the director of the laboratory to answer all questions related to its personnel and operations.)

Referring to FIG. 2, a flowchart illustrating a self-assessment process 200 according to an embodiment of the present invention is shown. That is, process 200 illustrates a user (e.g., a laboratory employee, in the above-mentioned embodiment where a laboratory medicine organization requires assessments for its personnel and procedures) using system 100 to conduct a self-assessment.

In step 202, a WWW “home” page is presented to a user accessing an ASP's (or the assessment/certifying competencies and compliance organization's) Web site using accessing device 102. In this step, process 200 allows the user to select the language they would like the system 100 to use (i.e., the language for the rest of process 200 and its associated GUI displays). In one embodiment, process 200 accepts an input from the user which is indicative of a short string locale representation from the Microsoft Visual Basic Scripting Edition Locale ID Chart (LCID) for the locale selected by the user (e.g., “en-us” for English—United States, “es-es” for Spanish —Spain, etc.). The user also selects the jurisdiction or sponsoring organization in step 202. The “home” page advertises the ASP's various offerings and gives details of each option. In an embodiment, such options include various self assessments and accreditation programs corresponding to one or more sponsoring organizations and standard-setting entities.

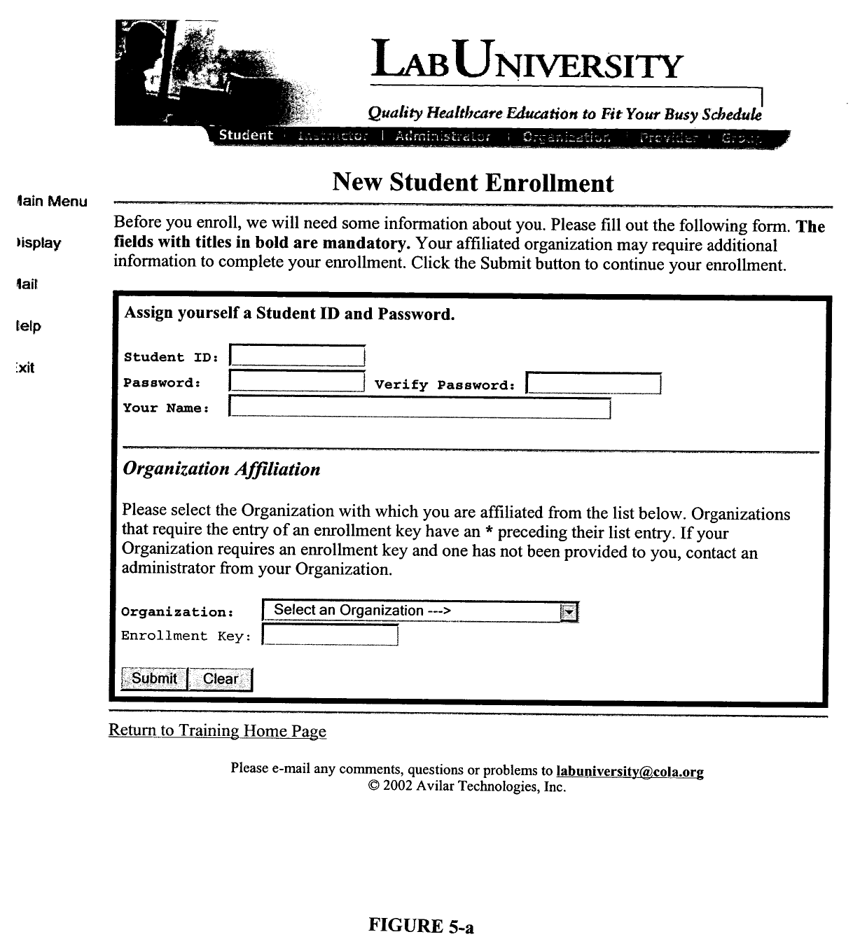

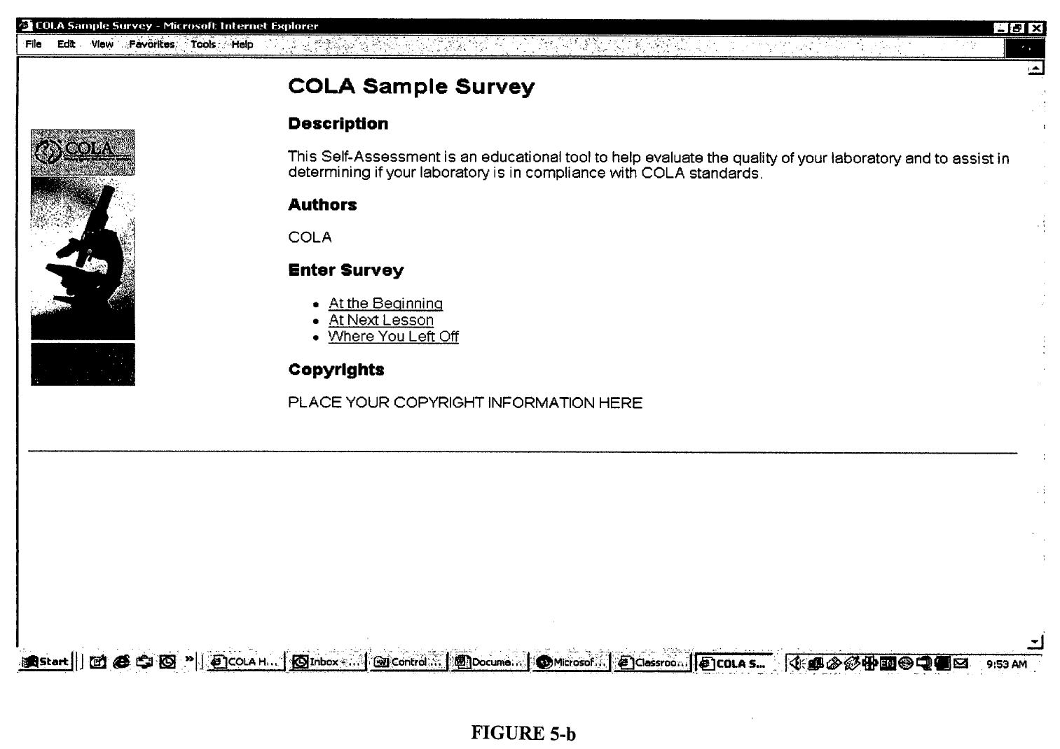

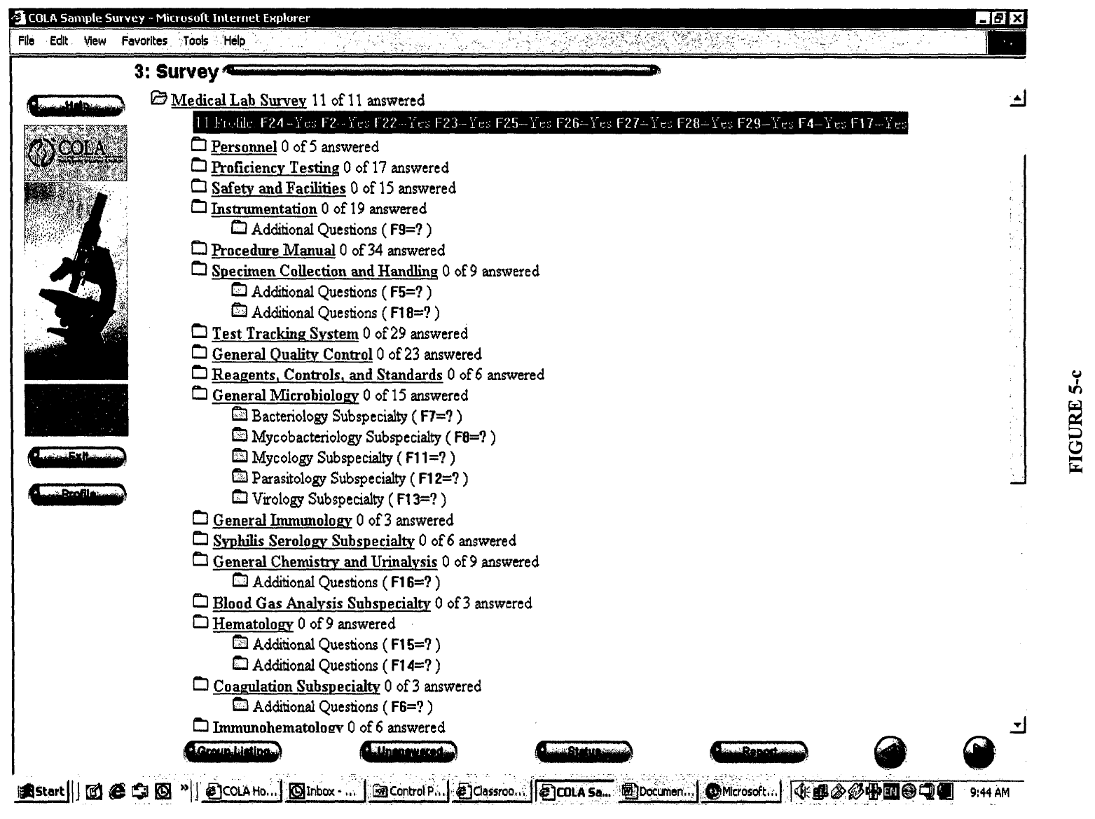

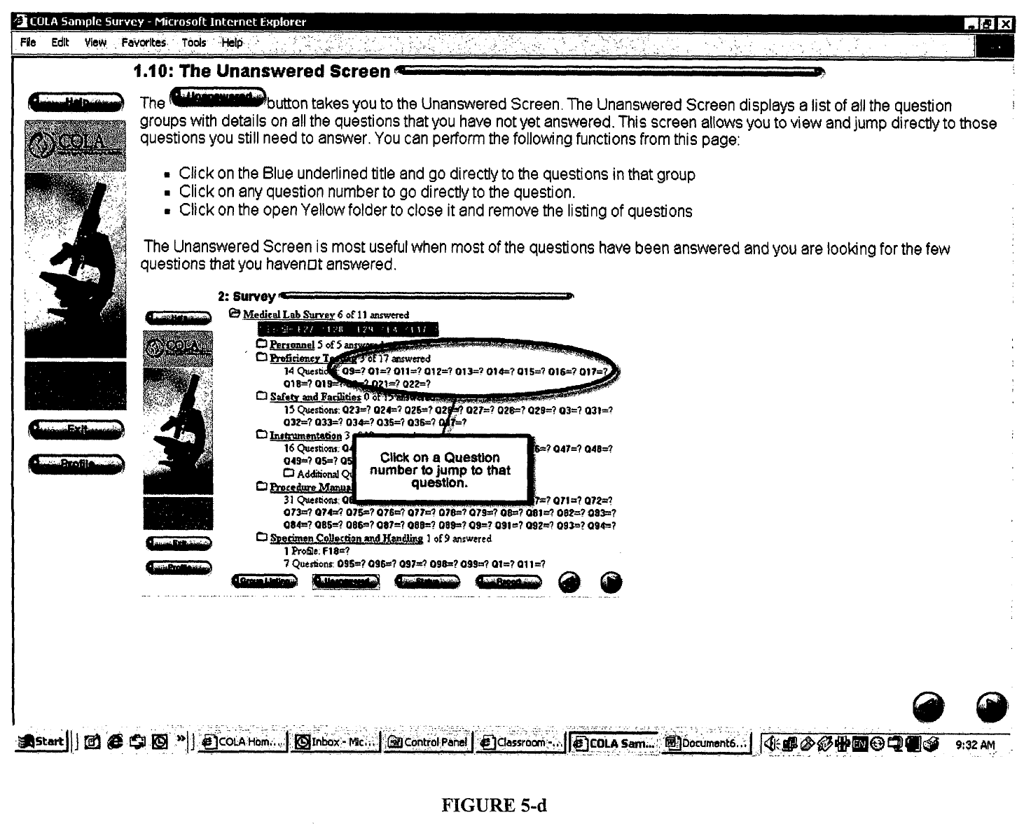

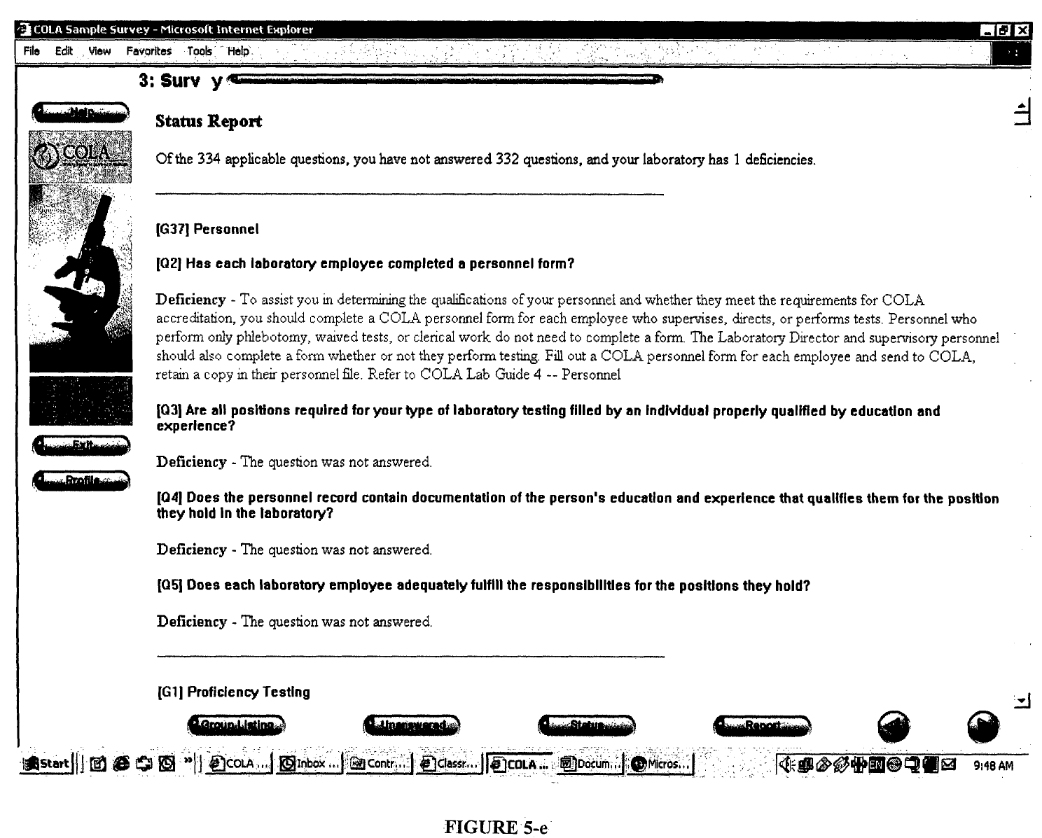

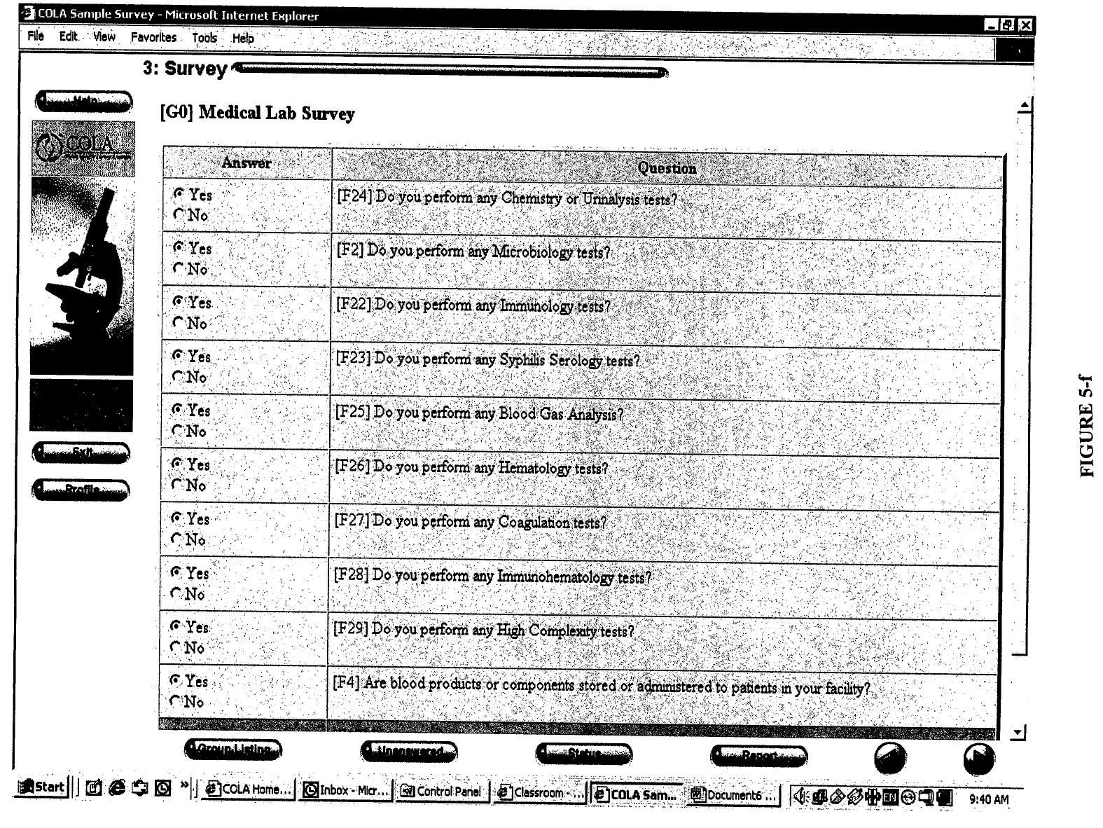

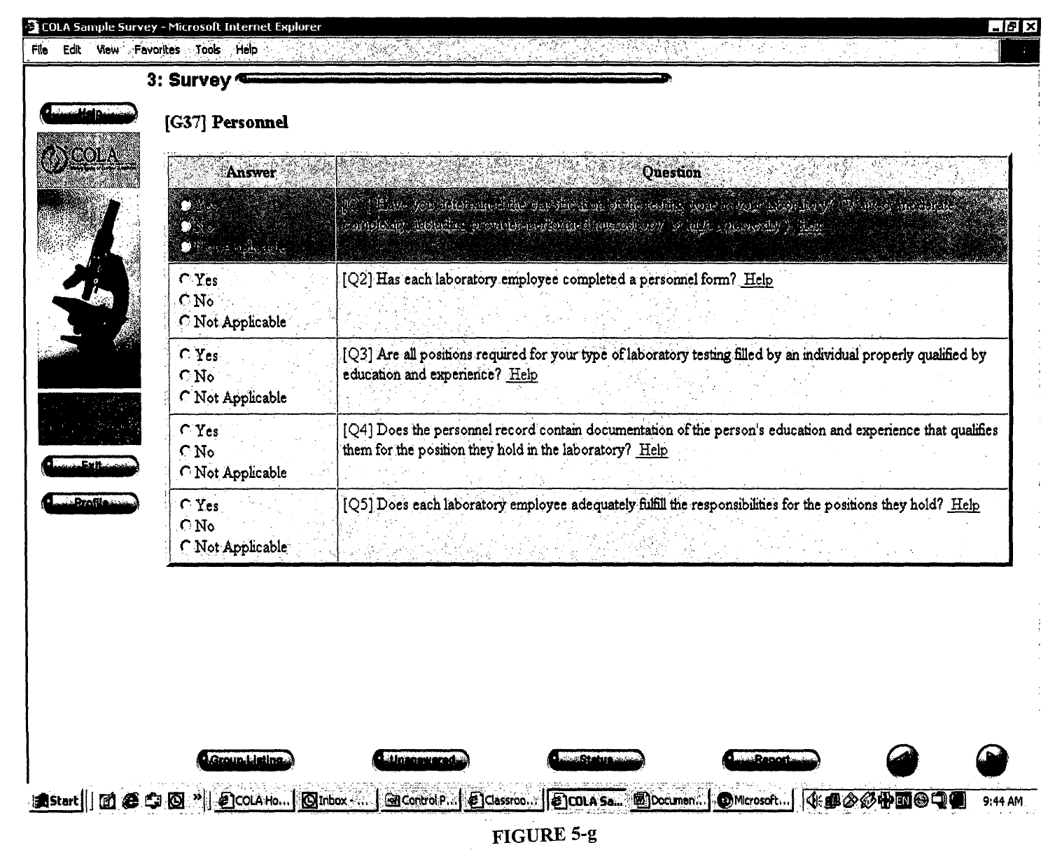

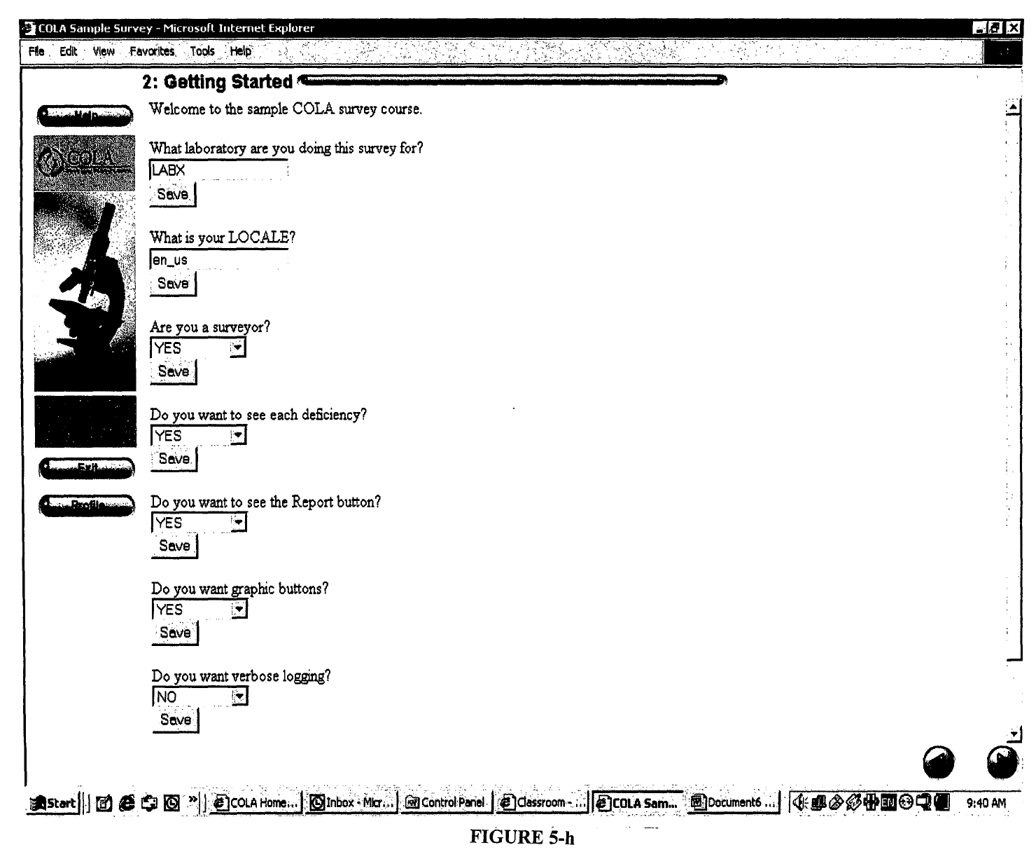

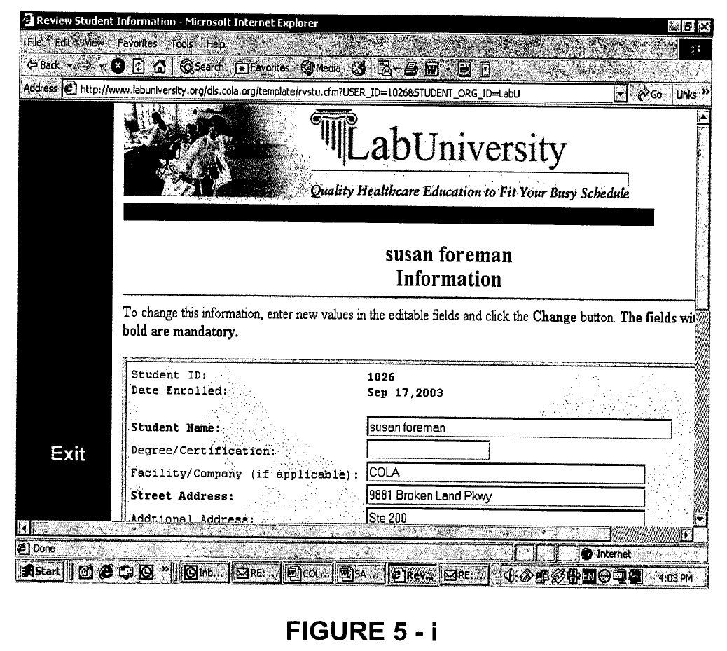

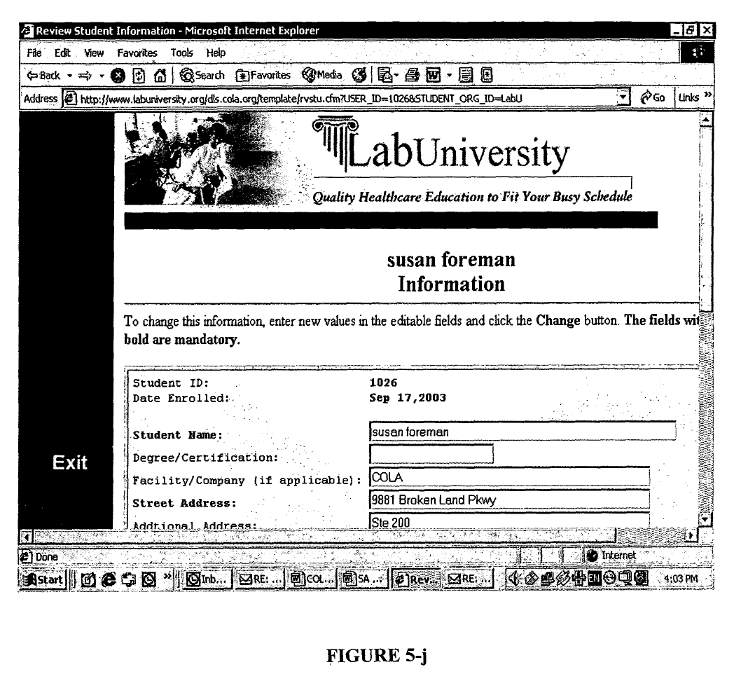

In step 204, process 200 queries the user for Student ID, password and general demographic information that identifies the user. (See FIGS. 5A and 51). In an embodiment, such information can include name, address, e-mail and jurisdiction/affiliation. As will be apparent to a person skilled in the relevant art(s) after reading this description herein, a validation process executing on server 106 may consult data stored on database 108 (e.g., login and password information) to ensure that each user accessing system 100 is a valid user. Further, any information collected from the user in step 204 (and during process 200 in general), is stored in database 108 and used by system 100 for aggregate reporting purposes.

In one embodiment, information obtained in step 204 is stored in database 108 for use during subsequent visits by the user. (See FIG. 5A.) In an embodiment, how long any user can have access to their information can be specified and can be pre-determined and controlled by the ASP.

In step 206, the user selects and pays the ASP for a product. In an embodiment, step 206 uses any one of the many commercially-available shopping cart products as will be known to one skilled in the relevant art(s). In alternate embodiments, the user may simply be authorized to debit their employer's account (e.g., in the above-mentioned embodiment where a laboratory medicine organization performs an assessment of its employees). In step 206, process 200 displays the proper course (i.e., a “course session”) based upon the language and jurisdiction entered in step 202. That is, the self-assessment course (i.e., a series of questions) corresponds to the standards promulgated by the jurisdiction in which the user is located and/or standards body organization with which the user is affiliated (i.e., the jurisdiction).

In an embodiment, a separate self-assessment course is created for every combination of jurisdiction/affiliation and language. For example, a course might be created for the United States in both English and Spanish and a different course created for Taiwan in both English and Chinese. Presumably, the reason for creating both a United States course and a Taiwanese course would be that they would contain some number of different questions and, perhaps, different introductory material and completion certificates due to different (jurisdictional/affiliation) standards for compliance certification.

In step 208, process 200 constructs a Laboratory Profile by asking a series of evaluation questions. Examples of information collected during step 208 are tests performed, specialties, instruments, personnel, and proficiency testing. This information is then used in the self-assessment course to determine which (appropriate) questions would be shown to the user. For example, if the specialty of microbiology is not conducted in the laboratory, the user would not be presented (i.e., would not have to answer) any microbiology-related self-assessment questions.

In step 210, the self assessment is conducted using any number of questions. In an embodiment, questions and responses are scalable and customizable. In one embodiment, questions would be answered “Yes,” “No,” or “Not Applicable,”. A “Help” function is also available. When “Help” is selected, in an embodiment, a help screen would be provided with each question. In an embodiment, when a “No” response is given to a question, a deficiency macro (i.e., one or more paragraphs of text providing education to the user on how to correct the deficiency so that in the future they will not need to answer “No” to the particular criteria) will be displayed.

In step 212, when a participant has completed their self-assessment (e.g., being based, in an embodiment, on each question being signed-off), a deficiency report will be generated. Such a report contains each question for which the user showed a deficiency, along with the deficiency macro. In an embodiment, this report is downloadable (i.e., available electronically) and printable. In alternate embodiments, outputs of process 200 include standard forms, guides and certificates of completion.

IV. Validation Operational Overview

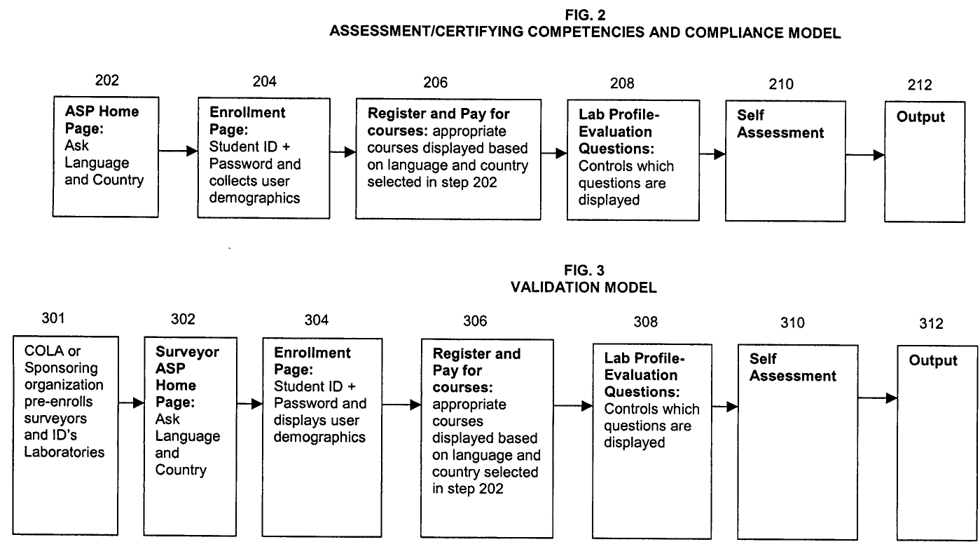

Referring to FIG. 3, a flowchart illustrating a surveyor validation process model according to an embodiment of the present invention is shown. That is, process 300 illustrates a surveyor (e.g., someone employed by the ASP or a standards-setting entity) using system 100 to perform an on-site, independent validation of an entity (e.g., a laboratory) and eventual certification.

In step 301, the ASP organization or a standards-setting entity would first enroll Surveyors and enters eligible laboratories into the system through steps 302-304, described below, thus creating a Student ID and Password and associated Surveyor demographics. The unique identification combination of Student ID and Password is provided to the Surveyor.

In step 302, a WWW “home” page is presented to a surveyor accessing the ASP's (or the assessment/certifying competencies and compliance organization's) Web site using accessing device 102. The “home” page, as will be apparent to a person skilled in the relevant art(s) after reading this description herein, facilitates a validation process executing on server 106 which consult data stored on database 108 so that surveyors may login to system 100 (e.g., using a student ID and password) to ensure that those accessing system 100 are indeed valid surveyors.

In step 302, process 300 allows the surveyor to select the language they would like system 100 to use (i.e., the language for the rest of process 300 and its associated GUI displays). In one embodiment, process 300 accepts an input from the user which is indicative of a short string locale representation from the Microsoft Visual Basic Scripting Edition Locale ID Chart (LCID) for the locale selected by the user (e.g., “en-us” for English—United States, “es-es” for Spanish—Spain, etc.).

In step 304, process 300 displays the surveyor's general demographic information that identifies the surveyor. In an embodiment, such information includes name, address, e-mail and jurisdiction/affiliation. In the above-mentioned embodiment where a laboratory medicine organization performs an assessment of its personnel and procedures based on a set of criteria, the surveyor-user would first have to select the particular laboratory they wish to evaluate from a list of enrolled laboratories (i.e., laboratories that have been identified in the system database 108). (See FIG. 5H.) In one embodiment, information obtained in step 304 is stored in database 108 for use during subsequent visits by the surveyor-user.

In step 306 the Surveyor selects and pays the ASP for a product. In an embodiment, step 306 uses any of the many commercially-available shopping cart products as will be known to one skilled in the relevant art(s). In alternate embodiments, the user may simply be authorized to debit their employer's account (e.g., in the above-mentioned embodiment where a laboratory medicine organization performs an assessment of its employees). In step 306, process 200 displays the proper course (i.e., a “course session”) based upon the language and jurisdiction entered in step 301. That is, the self-assessment course (i.e., a series of questions) corresponds to the standards promulgated by the jurisdiction in which the user is located and/or standards body organization with which the user is affiliated (i.e., the jurisdiction).

In step 308, process 300 constructs a Laboratory Profile by asking a series of evaluation questions. Examples of information collected during step 308 are tests performed, specialties, instruments, personnel, and proficiency testing. This information would be used in the self-assessment course to determine which questions would be shown to the Surveyor. For example, if the specialty of microbiology is not conducted in the laboratory, the Surveyor would not be presented (i.e., would not have to answer) any microbiology-related self-assessment questions.

In step 310, the self assessment is conducted using any number of questions. In an embodiment, questions would be answered “Yes,” “No,” “Not Applicable” along with a “Help” option. When “Help” option is selected, in an embodiment, the surveyor would be presented with text further interpreting the applicable question. As will be appreciated by those skilled in the relevant art(s) after reading the description herein, the questions posed to the surveyor are the same as those posed to the users (e.g., the laboratory which they are surveying).

In step 312, when the surveyor has completed their review, a deficiency report is generated. The report contains each question for which a deficiency was shown, along with the deficiency macro. (In an embodiment, this is the same report produced by process 200.) In an embodiment, this report is downloadable (i.e., available electronically) and printable. In alternate embodiments, outputs of process 300 include standard forms, guides and certificates of completion.

In an embodiment, a Certificate of Accreditation/Certification based on the sponsoring organization and/or its personnel obtaining a score (verified by the surveyor) greater than a pre-defined “cut-off” or “minimum passing score” may then be obtained; or, a feedback process for participants with scores lower than the cut-off to provide documentation of improvements is provided to allow for the removal of deficiencies to improve their score until a Certificate of Accreditation/Certification can be issued.

In an embodiment, questions are identified as being “Essential” (e.g., deemed critical to patient outcome) or “Required” (e.g., deemed important, but not critical to patient outcome). Then, weights (i.e., points) are assigned to each question based on certain degree of compliance (e.g., four points for full compliance, three points for substantial compliance; and one point for non-compliance). Then, a final “Essential” score is calculated at the end of a course session expressed as the quotient: (total “Essential” points)/(total number of “Essential” questions). Lastly, a final “Required” score is calculated at the end of a course session expressed as the quotient: (total “Required” points)/(total number of “Required” questions). In one embodiment, a “minimum passing score” is set to 4 for “Essential” criteria and a “cut-off” of ≧3.6 for “Required” criteria.

An example of a scoring scenario, in the above-mentioned embodiment where a laboratory medicine organization requires assessments for its personnel and procedures, is as follows for a self-assessment with 14 “Required” and 6 “Essential” criteria is shown in Table 2:

TABLE 2

| “Required” Criteria (14) | “Essential” Criteria (6) |
|---|---|
| 10 Full compliance * 4 = 40 | 5 Full compliance * 4 = 20 |
| 2 Substantial compliance * 3 = 6 | 1 Substantial compliance * 3 = 3 |
| 2 Non-compliant * 1 = 2 | Total = 23/6 = 3.8 |
| Total = 48/14 = 3.4 | This is not a passing score. |
| This is not a passing score. | |

As will be apparent to one skilled in the relevant art(s) after reading the description herein, in an embodiment, process 200 is used by an entity-user (e.g., laboratory) to perform a self-assessment in order to prepare for the actual, on-site certification/compliance process 300 performed by a surveyor-user (i.e., someone employed by the standards setting body) which then results in certification.

V. Self-Assessment Course Structure

In an embodiment, the present invention provides an authoring tool (executing on server 106 and accessible via GUI screens on accessing device 102) that allows assessment/certifying competencies and compliance organizations (e.g., educational organizations, nation-states, government agencies/ministries, professional societies, international/national standards setting organizations and the like) to create self-assessment courses.

In an embodiment, a general structure of a Laboratory Self-Assessment course includes five components: an optional Cover Page, one or more Introductory Units; a Question Unit; an optional Deficiency Report and an optional Certificate Unit. In such an embodiment, every course has a course template that defines the layout of the course screens. This layout includes any graphics required for buttons, logos, etc. Each course may use a different template.

In one embodiment, each course may have a Cover Page that displays a course-related image, a brief description of the course and links to the beginning of the course and to the location in the course last accessed by the user (if applicable). The cover page can also include browser testing and feedback to alert the user to any potential incompatibilities that might be encountered attempting to display the course in the user's browser on device 102. (See FIG. 5B.)

A self-assessment course, in an embodiment, may have any number of Introductory Units that precede the Question Unit. The Introductory Units can contain any information deemed appropriate for the course. Each Introductory Unit is one or more displayed pages that provide any information that is pertinent to the end user such as instructions for navigating through the Self-Assessment course. (See FIG. 5D).

In an embodiment, a self-assessment course includes a Question Unit which includes one more groups of related self-assessment and/or evaluation questions. System 100 provides a hierarchical Question Navigation Table that will permit a user to navigate directly to question groups during a course session. (See FIG. 5C.)

In an embodiment, a question group may contain an introduction screen that is displayed when the question group is entered from the Question Navigation Table or encountered while sequentially answering questions. If a question group does not have an introduction screen, the first (evaluation or assessment) question in the group is displayed when the question group is entered.

In one embodiment, the authoring tool allows a user to create a Question Unit using Extensible Markup Language (XML) via an XML editor such as the XMLSP® XML software development tool available from Altova, Inc. of Beverly, Mass. Using XML enables a hierarchical (tree) Question Unit to be created consisting of question groups containing evaluation and/or assessment questions and other question groups, and to be navigated during a course session using the Question Navigation Table.

In an embodiment, the Question Navigation Table acts as a table of contents for question groups within the Question Unit of the course. In such an embodiment, the Question Navigation Table is displayed whenever a user enters the Question Unit. Also, whenever a question is displayed, a “Group Listing” button will be present on the GUI that will return to the Question Navigation Table when clicked. (See FIG. 5C.) Whenever a question group can be accessed, its title will appear as an active link in the Question Navigation Table. As suggested above, question groups may not be accessible because an evaluation question in a question group containing that group has not yet been answered or has been answered “No.” When a question group title is clicked, the corresponding question group record is accessed on database 108 and the group introduction screen id displayed (if one exists for the question group). If no group introduction screen exists for the question group, the first question in the question group will be displayed.

In one embodiment of the present invention, evaluation questions are the first question in a question group and have a “Yes” or “No” answer set. (For example: “Do you perform mycobacterial cultures?”) A user's answer to an evaluation question will be stored in database 108 and re-displayed whenever the user re-displays an evaluation question that it previously answered. An answer to an evaluation question will control the display of following assessment questions and other question groups contained within the group that it controls. That is, a “Yes” answer to an evaluation question will display the assessment questions and any question groups contained within its question group. However, a “No” answer will skip the entire contents of the question group, including any question groups contained within the present group. (See FIG. 5F.)

In an embodiment of the present invention, assessment questions maybe placed anywhere within a question group following the group's initial evaluation question (if applicable). In one embodiment, assessment questions have a “Yes,” “No” or “Not Applicable” answer set. (For example, “Does your laboratory policy prohibit communication with another laboratory to discuss Proficiency Testing results prior to the cut-off date for submission of test results for that event?”) A user's answers to assessment questions will be stored in database 108 and re-displayed whenever the user re-displays an assessment question that it previously answered. (See FIG. 5G.) In an embodiment, answers to assessment questions are scored for eventual display to and report generation by a surveyor.

In one embodiment, whenever a user answers “No” to an assessment question, a deficiency macro (information intended to educate the user on how to correct the deficiency) is displayed (e.g., in a pop-up window). (See FIG. 5G.)

In an embodiment, the GUI of system 100 includes an Unanswered Questions Navigation Table that shows the number of questions answered for each question group and the total number of questions in that group. Accessible groups can be expanded to show the questions within the group by clicking on a file folder icon displayed next to the question group title. The user can proceed directly to a question by clicking on its question number which appears under the group title. (See FIG. 5D.)

In an embodiment, the GUI of system 100 has the ability to produce a status report upon the user clicking a “Status” button. The status report shows the total number of applicable questions, the number of unanswered questions, and the total number of deficiencies. The user can then jump directly to any question by clicking on the question number which displays next to the text of the question. This report is useful when most of the questions of the Question Unit have been answered, and the user is searching for the few remaining unanswered questions. (See FIG. 5E.)

A self-assessment course, in an embodiment, includes a Deficiency Report component that displays deficiency macros (information intended to educate the user on how to correct the deficiency) for all of the assessment questions to which the user has responded “No.” (See FIG. 5G). The deficiency report will be organized by question group using the question group title, if any, as a heading along with the question text and the deficiency macro. Because it is possible that the deficiency report will contain a significant amount of text, in one embodiment an option is provided to download the report for offline display and printing. In such an embodiment, the deficiency report may be accessed at any time by clicking a GUI “Report” button. The report generated will contain deficiency macros for those questions to which the user has given a deficient response (e.g., the user has given a “No” answer which means the laboratory is not compliant with that question, i.e., it is deficient) up to the time that the report is generated. This will permit a user to run a deficiency report at any time during processes 200 and 300.

Table 1 lists additional reports which, in alternate embodiments, maybe created and accessed by a user.

TABLE 1

| Report | Description |
|---|---|
| User Progress | Shows the assessment questions that have been |
| | answered and the answers given. This report is |
| | available to administrators, managerial personnel |
| | and instructors for individual users |
| | registered for self-assessment courses. |
| Laboratory Scores | Shows the scores achieved by all users |
| | evaluated by the Surveyor. This report is available to |
| | Surveyor organization administrators and instructors |
| | for individual Surveyors |
| | registered for self-assessment courses. |
| Question | Shows each assessment question along |
| Summary | with the number of times it was answered |
| | “Yes,” “No” or |
| | “Not Applicable” and available to |
| | administrators, managerial personnel and |
| | instructors. |

A self-assessment course, in an embodiment, includes a Certificate Unit component that determines if the (sponsoring organization or surveyor) user has answered all of the assessment questions that were asked of it during the course session. If not, a message so indicating will be displayed. A link will be present to send the user back to the Question Unit which will direct the user to the last question answered so that it can continue the assessment process. If the user has answered all of the assessment questions asked of it, a certificate designed by the applicable assessment/certifying competencies and compliance organization will be displayed. The user may then print this certificate or download it for offline printing which serves as proof of its compliance.

VI. Example Implementations

The present invention (system 100, processes 200-300 or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

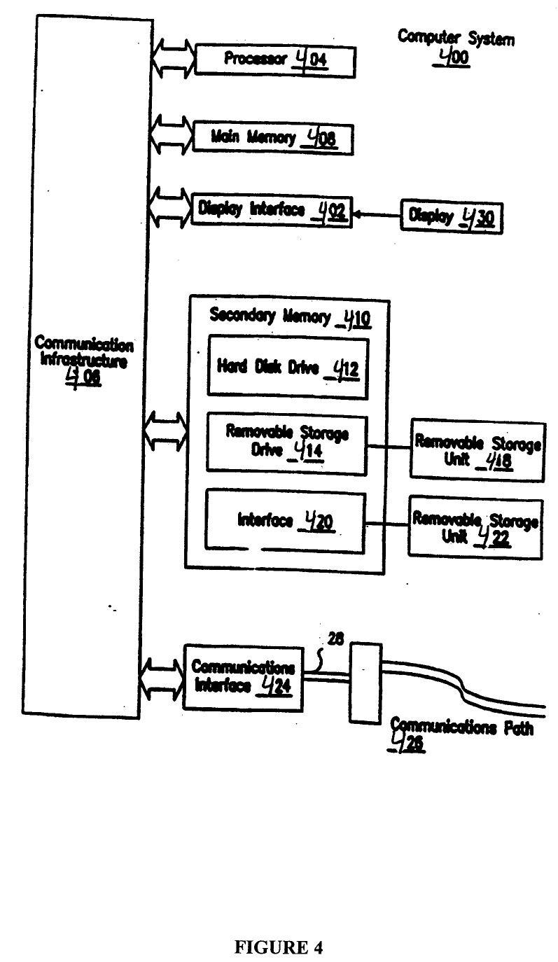

In fact, in one embodiment, the invention is directed toward one or more computer systems capable of carrying out the functionality described herein. An example of a computer system 400 is shown in FIG. 4.

The computer system 400 includes one or more processors, such as processor 404. The processor 404 is connected to a communication infrastructure 406 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 400 can include a display interface 402 that forwards graphics, text, and other data from the communication infrastructure 406 (or from a frame buffer not shown) for display on the display unit 430.

Computer system 400 also includes a main memory 408, preferably random access memory (RAM), and may also include a secondary memory 410. The secondary memory 410 may include, for example, a hard disk drive 412 and/or a removable storage drive 414, representing a floppy disk drive, a magnetic tape drive, an optical disk drive, etc. The removable storage drive 414 reads from and/or writes to a removable storage unit 418 in a well known manner. Removable storage unit 418 represents a floppy disk, magnetic tape, optical disk, etc. which is read by and written to by removable storage drive 414. As will be appreciated, the removable storage unit 418 includes a computer usable storage medium having stored therein computer software and/or data.

In alternative embodiments, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428 which may be electronic, electromagnetic, optical or other signals capable of being received by communications interface 424. These signals 428 are provided to communications interface 424 via a communications path (e.g., channel) 426. This channel 426 carries signals 428 and maybe implemented using wire or cable, fiber optics, a telephone line, a cellular link, an radio frequency (RF) link and other communications channels.

In this document, the terms “computer program medium” and “computer usable medium” are used to generally refer to media such as removable storage drive 414, a hard disk installed in hard disk drive 412, and signals 428. These computer program products provide software to computer system 400. The invention is directed to such computer program products.

Computer programs (also referred to as computer control logic) are stored in main memory 408 and/or secondary memory 410. Computer programs may also be received via communications interface 424. Such computer programs, when executed, enable the computer system 400 to perform the features of the present invention, as discussed herein. In particular, the computer programs, when executed, enable the processor 404 to perform the features of the present invention. Accordingly, such computer programs represent controllers of the computer system 400.

In an embodiment where the invention is implemented using software, the software may be stored in a computer program product and loaded into computer system 400 using removable storage drive 414, hard drive 412 or communications interface 424. The control logic (software), when executed by the processor 404, causes the processor 404 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### VII. CONCLUSION

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above-described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A system for allowing a user to perform an assessment for compliance certification, comprising:
a database storing a plurality of evaluation questions and a plurality of assessment questions, wherein subsets of said plurality of evaluation and assessment questions are combinable to form a plurality of assessment courses; and
a server, connected to said database via a communications network, having a processor configured to cause a graphical user interface to be displayed to a network access device connected to said server via said communications network;
wherein said processor is further configured to present to the user, via said graphical user interface, at least one of said plurality of assessment courses; receive responses from the user to the subset of said plurality of evaluation and assessment questions comprising said at least one of said plurality of assessment courses.

2. The system of claim 1, further comprising:
a first plurality of minimum scores, stored in said database, each corresponding to one of the subset of said plurality of evaluation questions included in each of said plurality of assessment courses.

3. The system of claim 2, further comprising:
a second plurality of minimum scores, stored in said database, each corresponding to one of the subset of said plurality of evaluation questions included in each of said plurality of assessment courses.

4. The system of claim 3, wherein said processor is further configured to calculate a first score based on said response to the subset of said plurality of evaluation questions comprising said at least one of said plurality of assessment courses.

5. The system of claim 4, wherein said processor is further configured to calculate a second score based on said response to the subset of said plurality of assessment questions comprising said at least one of said plurality of assessment courses.

6. The system of claim 5, wherein said processor is further configured to determine whether said first score is equal to or exceeds one of said first plurality of minimum scores corresponding to the subset of said plurality of evaluation questions comprising said at least one of said plurality of assessment courses.

7. The system of claim 6, wherein said processor is further configured to determine whether said second score is equal to or exceeds one of said second plurality of minimum scores corresponding to the subset of said plurality of assessment questions comprising said at least one of said plurality of assessment courses.

8. The system of claim 1, wherein said communications network is at least a portion of the global, public Internet.

9. The system of claim 1, wherein each of said responses received from the user to the subset of said plurality of evaluation questions comprising said at least one of said plurality of assessment courses is indicative of one of the following: “Yes”; and “No”.

10. The system of claim 1, wherein each of said responses received from the user to the subset of said plurality of assessment questions comprising said at least one of said plurality of assessment courses is indicative of one of the following: “Yes”; “No”; and “Not Applicable”.

11. A computer-implemented method for allowing users to remotely perform assessments for compliance certification, comprising the steps of:
storing a plurality of evaluation questions and a plurality of assessment questions, wherein subsets of said plurality of evaluation and assessment questions are combinable to form a plurality of assessment courses;
causing a graphical user interface to be displayed, over a communications network, to a user;
receiving a selection from said user, via said graphical user interface, wherein said selection is indicative of one of said plurality of assessment courses;
presenting to said user, via said graphical user interface, the subset of said plurality of evaluation and assessment questions comprising said at least one of said plurality of assessment courses; and
receiving a plurality of responses from said user to the subset of said plurality of evaluation and assessment questions comprising said at least one of said plurality of assessment courses;
whereby said plurality of responses can be scored in order to determine whether said user should receive a certification for said at least one of said plurality of assessment courses.

12. The method of claim 11, further comprising the steps of:
storing a first plurality of minimum scores, each corresponding to one of the subset of said plurality of evaluation questions comprising said at least one of said plurality of assessment courses; and
storing a second plurality of minimum scores, each corresponding to one of the subset of said plurality of assessment questions comprising said at least one of said plurality of assessment courses.

13. The method of claim 12, further comprising the steps of:
calculating a first score based on said plurality of response to the subset of said plurality of evaluation questions comprising said at least one of said plurality of assessment courses;
calculating a second score based on said plurality of response to the subset of said plurality of assessment questions comprising said at least one of said plurality of assessment courses;
determining whether said first score is equal to or exceeds one of said first plurality of minimum scores corresponding to the subset of said plurality of evaluation questions comprising said at least one of said plurality of assessment courses; and
determining whether said second score is equal to or exceeds one of said second plurality of minimum scores corresponding to the subset of said plurality of assessment questions comprising said at least one of said plurality of assessment courses.

14. The method of claim 13, further comprising the step of:
presenting to said user, via said graphical user interface, an indication that they are to receive a certification for said at least one of said plurality of assessment courses when both said determination steps are positive.

15. The method of claim 13, wherein each of said plurality of responses to the subset of said plurality of evaluation questions comprising said at least one of said plurality of assessment courses is indicative of one of the following: “Yes”; and “No”.

16. The method of claim 15, wherein a weight is assigned to each of said plurality of responses to the subset of said plurality of evaluation questions comprising said at least one of said plurality of assessment courses.

17. The method of claim 15, further comprising the step of:
displaying a deficiency macro to said user, via said graphical user interface, when one of said plurality of responses to the subset of said plurality of evaluation questions comprising said at least one of said plurality of assessment courses is indicative of “No”.

18. The method of claim 13, wherein each of said plurality of responses to the subset of said plurality of assessment questions comprising said at least one of said plurality of assessment courses is indicative of one of the following: “Yes”; “No”; and “Not Applicable”.

19. The method of claim 17, wherein a weight is assigned to each of said plurality of responses to the subset of said plurality of assessment questions comprising said at least one of said plurality of assessment courses.

20. The method of claim 17, further comprising the step of:
displaying a deficiency macro to said user, via said graphical user interface, when one of said plurality of responses to the subset of said plurality of assessment questions comprising said at least one of said plurality of assessment courses is indicative of “No”.

21. The method of claim 11, wherein said communications network is at least a portion of the global, public Internet.

22. A computer program product comprising a computer usable medium having control logic stored therein for causing a computer to perform assessments for compliance certification, said control logic comprising:
first computer readable program code means for causing the computer to store a plurality of evaluation questions and a plurality of assessment questions, wherein subsets of said plurality of evaluation and assessment questions are combinable to form a plurality of assessment courses;
second computer readable program code means for causing the computer to display a graphical user interface, over a communications network, to a user;
third computer readable program code means for causing the computer to receive a selection from said user, via said graphical user interface, wherein said selection is indicative of one of said plurality of assessment courses;
fourth computer readable program code means for causing the computer to present to said user, via said graphical user interface, the subset of said plurality of evaluation and assessment questions comprising said at least one of said plurality of assessment courses; and
fifth computer readable program code means for causing the computer to receive a plurality of responses from said user to the subset of said plurality of evaluation and assessment questions comprising said at least one of said plurality of assessment courses;
whereby said plurality of responses can be scored in order to determine whether said user should receive a certification for said at least one of said plurality of assessment courses.

23. The computer program product of claim 22, further comprising:
sixth computer readable program code means for causing the computer to store a first plurality of minimum scores, each corresponding to one of the subset of said plurality of evaluation questions comprising said at least one of said plurality of assessment courses; and
seventh computer readable program code means for causing the computer to store a second plurality of minimum scores, each corresponding to one of the subset of said plurality of assessment questions comprising said at least one of said plurality of assessment courses.

24. The computer program product of claim 23, further comprising:
eighth computer readable program code means for causing the computer to calculate a first score based on said plurality of response to the subset of said plurality of evaluation questions comprising said at least one of said plurality of assessment courses;
ninth computer readable program code means for causing the computer to calculate a second score based on said plurality of response to the subset of said plurality of assessment questions comprising said at least one of said plurality of assessment courses;
tenth computer readable program code means for causing the computer to determine whether said first score is equal to or exceeds one of said first plurality of minimum scores corresponding to the subset of said plurality of evaluation questions comprising said at least one of said plurality of assessment courses; and
eleventh computer readable program code means for causing the computer to determine whether said second score is equal to or exceeds one of said second plurality of minimum scores corresponding to the subset of said plurality of assessment questions comprising said at least one of said plurality of assessment courses.
